(19) United States
(12) Patent Application Publication
(10) Pub. No.: US 2009/0043492 A1
(43) Pub. Date: Feb. 12, 2009

(54) Information guidance systems, methods, and programs

(75) Inventors: Takaaki Nakayama, Okazaki (JP); Hiroshi Kawauchi, Kariya (JP)

Correspondence Address: OLIFF & BERRIDGE, PLC, P.O. BOX 320850, ALEXANDRIA, VA, 22320-4850, US

(73) Assignee: AISIN AW CO., LTD., Anjo-Shi (JP)

(21) Appl. No.: 12/222,429

(22) Filed: Aug. 8, 2008

(30) Foreign Application Priority Data
Aug. 10, 2007 (JP) 2007-209275

(51) Int. Cl. G01C 21/36

(52) U.S. Cl. 701/202; 701/201

(57) ABSTRACT

Information guidance systems, methods, and programs search for a route from a departure point to a destination and identify a facility used for performing guidance for a guidance location on the searched route. The systems, methods, and programs determine whether a name of the facility has been changed. When the name has been changed, the systems, methods, and programs perform guidance notifying that the name has been changed.

### INCORPORATION BY REFERENCE

The disclosure of Japanese Patent Application No. 2007-209275, filed on Aug. 10, 2007, including the specification, drawings, and abstract is incorporated herein by reference in its entirety.

### BACKGROUND

1. Related Technical Fields

Related technical fields include information guidance systems, methods, and programs.

2. Related Art

In a related-art navigation device, a present position of a vehicle is detected by, for example, a global positioning system (GPS). Map data is read from a data record section and a map screen is formed on a display section. The vehicle position and a map of a vicinity of the vehicle position are displayed on the map screen. Thus, a driver can drive the vehicle in accordance with the vehicle position displayed on the map screen.

When the driver inputs a destination and sets a search condition, a route search process is performed whereby a route from the present position to the destination is searched based on the map data and the search condition. The searched route is displayed together with the vehicle position on the map screen, and route guidance is performed. Thus, the driver can drive the vehicle along the displayed searched route.

In some cases, route guidance is performed using a name of a facility. For example, when the vehicle needs to make a right or left turn at a predetermined intersection, the intersection is set as a guidance intersection, and the route guidance is performed before the vehicle reaches the guidance intersection by outputting a voice.

Besides the route guidance at the guidance intersection, when the vehicle needs to pass a predetermined facility, a facility is set as a guidance facility, and the route guidance is performed before the vehicle reaches the guidance facility by outputting a voice.

To this end, one or more guidance output locations are set slightly before the guidance intersection or the guidance facility on the searched route by a set distance, so that when the vehicle reaches the respective guidance output locations a guidance phrase such as “proceed toward xx hall at intersection n about 300 meters forward,” or “xx hall is about 50 meters forward,” is output by voice. Such a navigation device is described, for example, in Japanese Patent Application Publication No. JP-A-11-351900.

### SUMMARY

There are cases where, for example, the name of a facility is changed due to circumstances such as a change of an owner of the facility. In that case, data is updated by a producer of the map data, whereby the driver can acquire the updated data via an update disk, a network, or the like and record the data in a data record section.

However, in the related-art navigation device, there are cases where data of a new name is recorded in the data record section, while the name of facility indicated by a road indication, a guidance board, or the like on an actual road is not changed. In that case, the name of the facility used in the route guidance differs from the name of the facility used on the actual road. In this circumstance, the driver cannot drive the vehicle smoothly in accordance with the route guidance.

If the name of the facility indicated by the road indication, the guidance board, or the like has been changed, and the driver does not know the changed name while the name of the facility used in the route guidance differs from what the driver knows, the driver cannot drive the vehicle smoothly in accordance with the route guidance.

Exemplary implementations of the broad inventive principles described herein provide information guidance systems, methods, and programs that allow a vehicle to be driven smoothly in accordance with route guidance even under the above circumstances.

Exemplary implementations provide systems, methods, and programs that search for a route from a departure point to a destination and identify a facility used for performing guidance for a guidance location on the searched route. The systems, methods, and programs determine whether a name of the facility has been changed. When the name has been changed, the systems, methods, and programs perform guidance notifying that the name has been changed.

### BRIEF DESCRIPTION OF THE DRAWINGS

Exemplary implementations will now be described with reference to the accompanying drawings, wherein:

FIG. 1 is a view showing an exemplary navigation system;

FIG. 2 is a flowchart showing an exemplary guidance method; and

FIG. 3 is a flowchart showing an exemplary guidance method.

### DETAILED DESCRIPTION OF EXEMPLARY IMPLEMENTATIONS

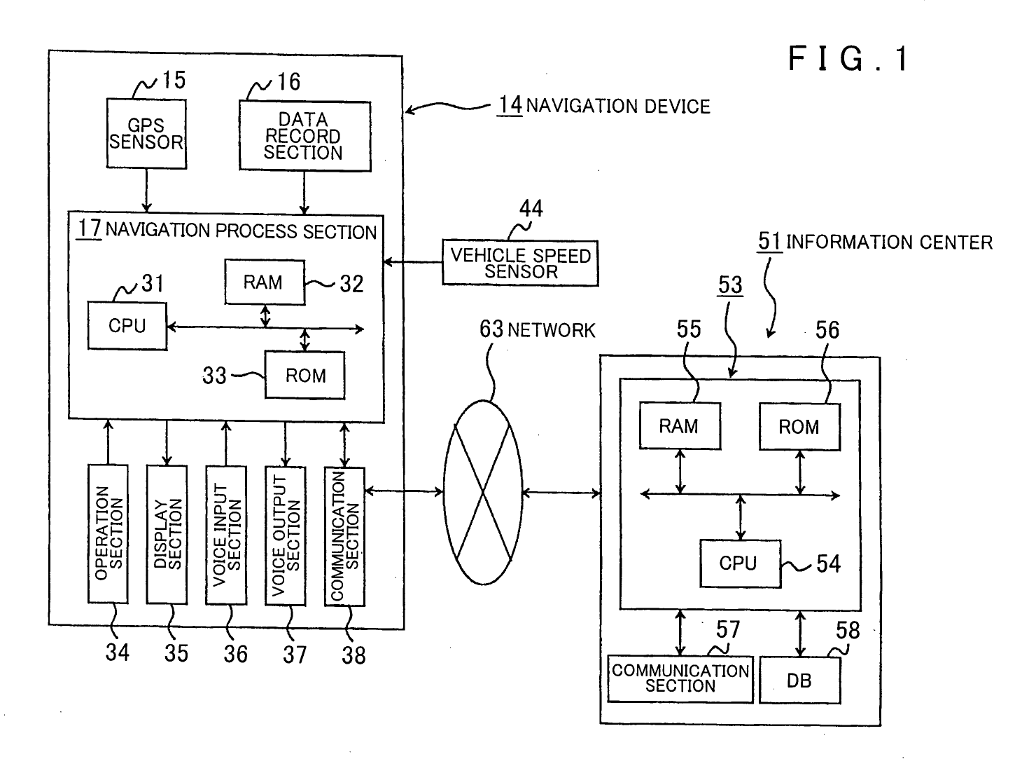

FIG. 1 is a view showing an exemplary navigation system. The navigation system includes an information terminal 14 (e.g., a navigation device mounted on a vehicle), a network 63, and an information center 51 as an information provider.

The navigation device 14 includes a GPS sensor 15 that detects a direction of a vehicle, a present vehicle position, and a time, a data record section 16 in which map data and various information are recorded, and a navigation process section 17 that performs various arithmetic processes such as a navigation process. The navigation device 14 includes an operation section 34 for performing a predetermined input by an operation by a driver, a display section 35 for performing various displays using an image displayed on a screen (not shown) for notification to the driver, and a voice input section 36 for performing a predetermined input by a voice of the driver. The navigation device 14 includes a voice output section 37 for performing a voice output to notify the driver of various information and a communication section 38 that functions as a communication terminal. The GPS sensor 15, the data record section 16, the operation section 34, the display section 35, the voice input section 36, the voice output section 37, and the communication section 38 are connected to the navigation process section 17. A vehicle speed sensor 44 or the like that detects a vehicle speed is also connected to the navigation process section 17. The vehicle direction may be detected by arranging a direction sensor independently from the GPS sensor 15.

The data record section 16 includes a map database formed of a map data file, and records map data in the map database. The map data includes intersection data, node data, road link data, search data, facility data, and feature data regarding features on roads.

As used herein, the term “link” refers to, for example, a road or portion of a road. For example, according to one type of road data, each road may consist of a plurality of componential units called links. Each link may be separated and defined by, for example, an intersection, an intersection having more than three roads, a curve, and/or a point at which the road type changes. As used herein the term “node” refers to a point connecting two links. A node may be, for example, an intersection, an intersection having more than three roads, a curve, and/or a point at which the road type changes.

A feature is an indicated object provided or formed on the road in order to provide various driving information to the driver and perform various driving guidance. A feature may be formed of an indication line, a road sign, a crosswalk, a manhole, a traffic light, or the like. Indication lines include a stop line for stopping the vehicle, a vehicle lane boundary line that divides each lane, and a segment line that represents a parking space. Road signs include a road indication for guidance of each direction at the intersection by paint using the name of the location, the name of the facility, or the like, a guidance board for guidance of each direction at the intersection using the name of the location, the name of the facility, or the like on a board, a passing zone sign that represents a travel direction of each lane using an arrow, and a guidance sign such as “STOP” that indicates a place for a temporary stop. The feature data includes position information representing a position of each feature using coordinates and the like and image information representing an image of each feature. The place for the temporary stop includes an entrance from a non-priority road to a priority road, a railroad crossing, an intersection with a blinking red light, and the like.

The data record section 16 is a type of memory that includes a disk (not shown), such as a hard disk, a CD, a DVD, and/or an optical disk, for recording the various data, and includes head (not shown) such as a read/write head for reading and writing various data. A memory card and the like may be used for the data record section 16. The disk, the memory card, and the like form an external storage device.

In this example, the map database is formed in the data record section 16, but the map database may also be formed in the information center 51.

The navigation process section 17 includes a controller (e.g., CPU 31) as an arithmetic device and as a control device which performs an overall control of the navigation device 14, a RAM 32 used as a working memory when the CPU 31 performs various arithmetic processes, a ROM 33 recording a control program and various programs for performing a searching of a route to a destination, a route guidance, and the like, and a flash memory (not shown) used for recording various data, programs, and the like. The RAM 32, the ROM 33, the flash memory, and the like form an internal storage device.

As the operation section 34, a keyboard, a mouse, and the like (not shown) arranged independently from the display section 35 may be used. Also, as the operation section 34, a touch panel may be used that allows a predetermined input operation to be performed by touching or clicking an image operation section such as various keys, switches, and buttons, displayed as an image on the screen formed in the display section 35.

A display is used as the display section 35, whereby the direction of the vehicle with the present vehicle position can be displayed. A map, a searched route, guidance information along the searched route, traffic information, and the like can be displayed on the display. A distance to the next intersection along the searched route and the travel direction at the next intersection can be displayed on the display.

The voice input section 36 is formed by a microphone (not shown) and the like, such that necessary information can be input by voice. The voice output section 37 includes a voice synthesis device and a speaker (not shown) such that the searched route, the guidance information, the traffic information, and the like are output from the voice output section 37 as, for example, a voice synthesized by the voice synthesis device.

The communication section 38 includes a beacon receiver (not shown) for receiving various information such as general information and current traffic information transmitted from a road traffic information center. The communication section 38 includes an FM receiver (not shown) for receiving various information as an FM multiplex broadcast via an FM broadcast station. The communication section 38 can receive data, such as the map data, and various kinds of information, such as the traffic information and the general information, from the information center 51 via the network 63.

To this end, the information center 51 includes a server 53, a communication section 57 connected to the server 53, and a database (DB) 58 as an information record section. The server 53 includes a controller (e.g., CPU 54) as a control device and as an arithmetic device, a RAM 55, and a ROM 56. The database 58 records data similar to the various data recorded in the data record section 16.

The navigation system, the navigation process section 17, the CPUs 31 and 54, the server 53, and the like function as a computer independently or in combination of two or more, and perform the arithmetic process based on various programs, data, and the like. The data record section 16, the RAMs 32 and 55, the ROMs 33 and 56, the database 58, the flash memory, and the like, alone or in various combinations, form one or more computer-readable storage mediums. As the arithmetic device, an MPU or the like instead of the CPUs 31 and 54 may be used.

Next, a basic operation of the navigation system having the configuration described above is described.

When the operation section 34 is operated by the driver and the navigation device 14 is started, the CPU 31 performs a present location read process and reads the vehicle position and vehicle direction detected by the GPS sensor 15. Next, the CPU 31 performs a matching process, and identifies the vehicle position by determining which road link the vehicle is on, based on a track of the read vehicle position and a shape, an alignment, and the like of each road link forming the roads in the vicinity of the vehicle position.

Next, the CPU 31 performs a basic information acquisition process, and reads and acquires the map data from the data record section 16, or receives and acquires the map data from the information center 51 or the like via the network 63 and the communication section 38. Note that, in the case of acquiring the map data from the information center 51 or the like, the CPU 31 downloads the received map data to the flash memory.

Next, the CPU 31 performs a display process, and forms various screens on the display section 35. For example, the CPU 31 performs a map display process and forms a map screen on the display section 35 to display a map of a surrounding area on the map screen and display the vehicle position and the vehicle direction. Thus, the driver can drive the vehicle in accordance with the map, the vehicle position, and the vehicle direction.

When the driver operates the operation section 34 to input the destination, the CPU 31 performs a destination setting process and sets the destination. Note that a departure point different from the vehicle's present location may be input and set if necessary. In addition, a predetermined location registered in advance may be set as the destination. Next, when the driver operates the operation section 34 to input a search condition, the CPU 31 performs a search condition setting process and sets the search condition.

When the destination and the search condition are set in this manner, the CPU 31 performs a route search process, reads the vehicle position, the vehicle direction, the destination, the search condition, and the like, reads search data and the like from the data record section 16, searches for the route from the departure point to the destination based on the vehicle position, the vehicle direction, the destination, the search data, and the like under the search condition, and outputs route data representing the searched route. A route in which a total of each link cost (e.g., an opportunity cost of traveling the link) given for each road link is smallest is used as the searched route.

Note that the route search process can be performed in the information center 51. In that case, the CPU 31 transmits the vehicle position, the vehicle direction, the destination, the search condition, and the like to the information center 51 via the network 63. When the information center 51 receives the vehicle position, the vehicle direction, the destination, the search condition, and the like, the CPU 54 performs a route search process similar to that of the CPU 31, reads the search data and the like from the database 58, searches for the route from the departure point to the destination under the search condition based on the vehicle position, the destination, and the search data, and outputs the route data representing the searched route. Next, the CPU 54 performs a transmission process, and transmits the route data to the navigation device 14 via the network 63.

Next, the CPU 31 performs a guidance process to perform route guidance. To this end, the CPU 31 performs a guidance display process, reads the route data, and displays the searched route on the map screen based on the route data.

When, for example, it is necessary that the vehicle make a right or left turn at the intersection that is a target location of the route guidance, the intersection is set as a guidance intersection, and the route guidance is performed by outputting the voice before the vehicle reaches the guidance intersection. Note that, on roads exclusively for automobiles such as an expressway, an urban expressway, and a toll road, an intersection that merges with or diverges at a junction and the like is also set as a guidance intersection.

Besides the route guidance at the guidance intersection, when it is necessary to perform the guidance for a predetermined facility, the facility is set as the guidance facility, and the route guidance for the guidance facility is performed before the vehicle reaches the guidance facility by outputting the voice. Note that each of the guidance intersection and the guidance facility are considered a guidance location. To this end, the CPU 31 performs a guidance location setting process, and sets the guidance intersection, the guidance facility, and the like based on the route data.

The CPU 31 performs a guidance output location setting process, and sets one or more predetermined locations (a plurality of locations in this example) that are slightly before the guidance intersection, the guidance facility, or the like on the searched route by a set distance from the guidance facility or the like, as guidance output locations. When the vehicle has reached the guidance output locations, the CPU 31 performs a voice output process to perform the voice output of a guidance phrase having a content set in advance for each guidance output location for the corresponding guidance intersection, the corresponding guidance facility, or the like.

The guidance phrase is set in advance in accordance with the distance from the guidance output location to the guidance intersection, the guidance facility, or the like, and is recorded in the data record section 16 as a guidance phrase map. The CPU 31 performs a location determination process, reads the position of the guidance intersection, the guidance facility, or the like and the vehicle position, calculates the distance from the vehicle position to the guidance intersection, the guidance facility, or the like, and determines whether the vehicle has approached the guidance intersection, the guidance facility, or the like and has reached the predetermined guidance output location. When the vehicle has reached the predetermined guidance output location, the voice output process unit refers to the guidance phrase map, reads the guidance phrase set in advance about the corresponding guidance intersection, the corresponding guidance facility, or the like at the respective guidance output locations, which the vehicle has reached, and performs the voice output.

The CPU 31 performs a guidance location enlarged view formation process, forms an intersection enlarged view as an enlarged view of the guidance intersection, i.e., a guidance location enlarged view, in a predetermined region of the map screen before the vehicle reaches the guidance intersection, and performs the route guidance using the intersection enlarged view. To this end, when the vehicle reaches a place that is slightly before (on the vehicle position side) the guidance intersection on the searched route by a predetermined distance, the intersection enlarged view is displayed. In this case, a landmark, such as a map of the vicinity of the guidance intersection, the searched route, and the facility, are displayed in the intersection enlarged view.

There are cases where the route guidance is performed using a name of a facility. In that case, when the vehicle has reached the predetermined guidance output location, the voice output process unit refers to the guidance phrase map, reads the guidance phrase set in advance about the corresponding guidance intersection, the corresponding guidance facility, or the like at the guidance output location, which the vehicle has reached, and outputs, for example, “proceed toward xx hall at intersection n in about 300 meters,” “xx hall is in about 50 meters,” or the like by the voice.

As discussed above, there are cases where, for example, the name of the facility is changed due to a circumstance such as a change of a facility owner. In that case, the data is updated by a producer of the map data, whereby the driver can acquire the updated data via an update disk, the network 63, and the like, and record the updated data in the data record section 16. The updated data includes data such as time and date when the name of the facility is changed. In this example, the driver operates the operation section 34 to acquire the updated data. To this end, the CPU 31 performs an update data acquisition process, acquires the updated data, and records the updated data in the data record section 16. Note that, when the updated data is acquired via the network 63, the CPU 31 may automatically acquire the updated data depending on a maintenance setting.

However, even if the new name of a facility, is recorded in the data record section 16, there are cases where the name of facility indicated by a road indication, a guidance board, or the like on the actual road is not yet changed. In that case, the name of the facility used in the route guidance differs from the name of the facility used on the actual road, whereby the driver may become confused by the different names and cannot drive the vehicle smoothly in accordance with the route guidance.

Similarly, if the name of the facility indicated by the road indication, the guidance sign, or the like has been changed, and the driver does not know the new name and the name of the facility used in the route guidance differ from what the driver knows, the driver cannot drive the vehicle smoothly in accordance with the route guidance.

In this example, when the updated data is acquired via the update disk, the network 63, and the like, guidance notifying that the name of the facility has been changed is performed when the route guidance is performed with the new name.

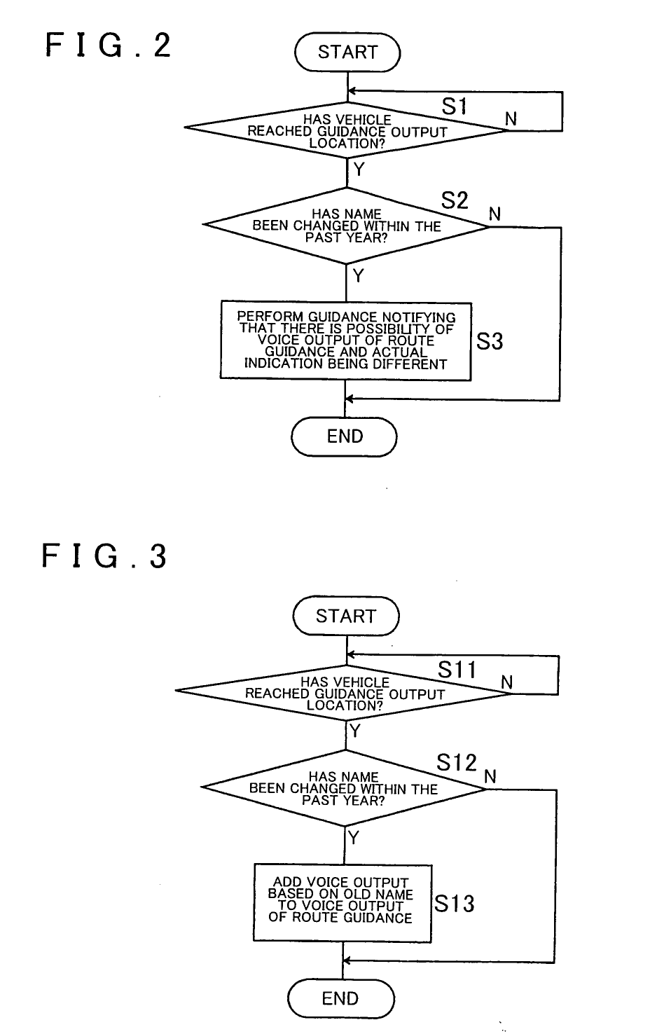

FIG. 2 is a flowchart showing an exemplary guidance method. The exemplary method may be implemented, for example, by one or more components of the above-described navigation system. For example, the exemplary method may be implemented by the CPU 31 and/or CPU 54 executing a computer program stored in the ROM 32, flash memory, data record section 16, ROM 56, and/or DB 58. However, even though the exemplary structure of the above-described navigation system may be referenced in the description, it should be appreciated that the structure is exemplary and the exemplary method need not be limited by any of the above-described exemplary structure. In the below example, the method is described as being implemented by the CPU 31 executing a program stored in the ROM 33.

First, the CPU 31 determines whether the vehicle has reached the predetermined guidance output location (S1). Next, when the vehicle reaches the guidance output location (S1=yes), the CPU 31, refers to the data record section 16, checks the map data, and determines whether the updated data about the guidance location corresponding to the guidance output location, which the vehicle has reached, is acquired. When it is determined that the updated data is acquired, the CPU 31 performs a name determination process. Specifically, the CPU 31 identifies a facility used for performing guidance at the guidance location based on the updated data. Also, the CPU 31 acquires data on time and date based on the updated data when the name of the facility was changed. The CPU 31 then determines whether the name of the identified facility has been changed within a predetermined period (within the past year in this example) (S2). If the name of the identified facility has been changed within the past year (S2=yes), the CPU 31 outputs the voice of the route guidance based on the new name, and performs guidance notifying that a voice output of the route guidance may differ from an actual road indication, an indication on the guidance board, or the like (S3). In this case, a guidance phrases such as, for example, besides “proceed toward xx hall at intersection n in about 300 meters,” “the name of xx hall has been changed recently” or “the indication on the guidance board may be different” are output.

In this example, if the name of the facility has been changed as described above, the guidance notifying that there is the possibility of the voice output of the route guidance and the actual indication being different is performed. Thus, the driver will be aware of the possibility of an inconsistency and can drive the vehicle smoothly in accordance with the route guidance, even if the name of the facility used in the route guidance and the name of the facility used in the actual road indication, the guidance board, or the like are different. Even if the driver does not know the new name, and the name of the facility used in the route guidance and the name of the facility known by the driver are different, the driver can drive the vehicle smoothly in accordance with the route guidance.

FIG. 3 is a flowchart showing another exemplary guidance method. The exemplary method may be implemented, for example, by one or more components of the above-described navigation system. For example, the exemplary method may be implemented by the CPU 31 and/or CPU 54 executing a computer program stored in the ROM 32, flash memory, data record section 16, ROM 56, and/or DB 58. However, even though the exemplary structure of the above-described navigation system may be referenced in the description, it should be appreciated that the structure is exemplary and the exemplary method need not be limited by any of the above-described exemplary structure. In the below example, the method is described as being implemented by the CPU 31 executing a program stored in the ROM 33. Steps that are substantially identical to those discussed with respect to FIG. 2 may be omitted from the following description.

In this example, when it is determined that the updated data about the guidance location corresponding to the guidance output location, which the vehicle has reached, is acquired, the CPU 31 identifies a facility used for performing guidance at the guidance location based on the updated data. Also, the CPU 31 aquires data on time and date when the name of the facility was changed based on the updated data. Then the CPU 31 determines whether the name of the identified facility has been changed within the predetermined period (within the past year in this example) (S12). If the name of the identified facility has been changed within the past year (S12=yes), the CPU 31 outputs the voice of the route guidance based on both the new name and the name before change. In this case, a guidance phrase such as, for example, “proceed toward xx hall formerly known as yy hall” is output.

While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

For example, in each example described above, the CPU 31 determines whether the vehicle has reached the predetermined guidance output location while the vehicle is being driven, and when the vehicle reaches the predetermined guidance output location, the CPU 31 refers to the data record section 16, checks the map data, and determines whether the updated data about the guidance location corresponding to the guidance output location, which the vehicle has reached, has been acquired. If the name of the facility used for performing guidance at the guidance location has been changed, the CPU 31 outputs the voice of the route guidance based on the new name, and performs the guidance notifying that there is the possibility of the name of the facility used for the route guidance and the name indication of the facility on the road indication, the guidance board, or the like being different. However, the guidance notifying that there is the possibility of the name of the facility used for the route guidance and the name indication of the facility on the road indication, the guidance board, or the like being different may be performed before driving of the vehicle is started.

In that case, for example, when the searched route is obtained in the route search process, the CPU 31 refers to the data record section 16, checks the map data, and determines whether the updated data about the guidance location on the searched route has been acquired, before the driving of the vehicle is started. If the name of the facility used for performing guidance at the guidance location on the searched route has been changed, the CPU 31 performs the guidance notifying that there is the possibility of the name of the facility used for the route guidance while the vehicle is being driven and the name indication of the facility on the road indication, the guidance board, or the like, which are set around the guidance location, being different. In this case, the guidance phrase such as, for example, “the name of the guidance location on the searched route has changed recently,” or “the indication on the guidance board may be different,” is output by voice.

In each example described above, the guidance notifying that the name of the facility has been changed is performed by the voice output. However, the guidance may be displayed on the screen of the display section 35. In that case, for example, the CPU 31 displays the guidance notifying that the name of the facility has been changed by a highlight display using a blink or the like.

What is claimed is:

1. An information guidance system for a vehicle, comprising:
a memory; and
a controller specifically configured to:
search for a route from a departure point to a destination;
identify a facility used for performing guidance for a guidance location on the searched route;
determine whether a name of the facility has been changed; and
when the name has been changed, perform guidance notifying that the name has been changed.

2. The information guidance system according to claim 1, wherein the controller is specifically configured to:
determine whether the vehicle has reached a guidance output location set before the guidance location in the direction of travel;
when the vehicle has reached the guidance output location, determine whether the name has been changed and perform the guidance notifying that the name has been changed.

3. The information guidance system according to claim 1, wherein the controller is specifically configured to:
determine whether the name has been changed and perform the guidance notifying that the name has been changed before driving of the vehicle along the searched route is started.

4. The information guidance system according to claim 1, wherein the guidance location is a guidance intersection.

5. The information guidance system according to claim 1, wherein the guidance location is the facility.

6. The information guidance system according to claim 1, wherein the controller is specifically configured to notify that the name of the facility used for performing guidance possibly differs from a name indication on a guidance board set around the guidance location.

7. The information guidance system according to claim 1, wherein controller is specifically configured to perform the guidance by outputting both the changed name of the facility and a name of the facility before the change.

8. The information guidance system according to claim 1, wherein the controller is specifically configured to perform the guidance by outputting a notification on a display.

9. The information guidance system according to claim 1, wherein the controller is specifically configured by executing a computer program stored in the memory.

10. An information guidance method for a vehicle, comprising:
searching for a route from a departure point to a destination;
identifying a facility used for performing guidance for a guidance location on the searched route;
determining whether a name of the facility has been changed; and
when the name has been changed, performing guidance notifying that the name has been changed.

11. The information guidance method according to claim 10, further comprising:
determining whether the vehicle has reached a guidance output location set before the guidance location in the direction of travel;
when the vehicle has reached the guidance output location, determining whether the name has been changed and performing the guidance notifying that the name has been changed.

12. The information guidance method according to claim 10, further comprising:
determining whether the name has been changed; and
performing the guidance notifying that the name has been changed before driving of the vehicle along the searched route is started.

13. The information guidance method according to claim 10, wherein the guidance location is a guidance intersection.

14. The information guidance method according to claim 10, wherein the guidance location is the facility.

15. The information guidance method according to claim 10, further comprising notifying that the name of the facility used for performing guidance possibly differs from a name indication on a guidance board set around the guidance location.

16. The information guidance method according to claim 10, further comprising performing the guidance by outputting both the changed name of the facility and a name of the facility before the change.

17. The information guidance method according to claim 10, further comprising performing the guidance by outputting a notification on a display.

18. The information guidance method according to claim 10, wherein the method is implemented by a controller.

19. A computer-readable storage medium storing a computer-executable program usable to provide guidance information, the program comprising:
instructions for searching for a route from a departure point to a destination;
instructions for identifying a facility used for performing guidance for a guidance location on the searched route;
instructions for determining whether a name of the facility has been changed; and
instructions for performing guidance notifying that the name has been changed when the name has been changed.
